(19) United States
(12) Patent Application Publication
(10) Pub. No.: US 2008/0205942 A1
(43) Pub. Date: Aug. 28, 2008

(54) Developing Roller, Developing Unit, and Image Forming Apparatus

(75) Inventors: Hiroshi TOYAMA, Shiojiri-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/037,771

(22) Filed: Feb. 26, 2008

(30) Foreign Application Priority Data
Feb. 27, 2007 (JP) 2007-047821

(51) Int. Cl. G03G 15/08

(52) U.S. Cl. 399/279

(57) ABSTRACT

A developing roller includes a hollow cylindrical or solid cylindrical main body having a grooved portion that is formed in the outer circumferential surface of the main body and that supports toner. The grooved portion includes a plurality of first grooves parallel to each other and a plurality of second grooves parallel to each other and intersecting with the first grooves. The centers of four intersections at which adjacent two of the first grooves and adjacent two of the second grooves intersect differ from each other in the position in the direction of the axis of the main body.

### BACKGROUND

1. Technical Field

The present invention relates to a developing roller, a developing unit, and an image forming apparatus.

2. Related Art

Electrophotographic image forming apparatuses such as printers, copying machines, and facsimiles form an image with toner on a recording medium such as paper through a series of image forming processes such as charging process, exposing process, developing process, transfer process, and fixing process.

Such an image forming apparatus has a developing unit that is disposed opposite a photosensitive drum supporting an electrostatic latent image and that has a developing roller supporting toner. In the developing process, such a developing unit supplies toner to the photosensitive drum from the developing roller, thereby making the latent image on the photosensitive drum a visible toner image.

Heretofore, there is known a developing roller having a regularly grooved portion formed in the surface thereof, for example, by rolling (see, for example, JP-A-2000-56558).

The grooved portion of the developing roller of JP-A-2000-56558 includes a plurality of first grooves parallel to each other, and a plurality of second grooves parallel to each other and intersecting with the first grooves.

Such a regularly grooved portion has improved durability because the width of the top of each protrusion thereof is comparatively large.

However, in the developing roller of JP-A-2000-56558, portions in which intersections of the first and second grooves exist and portions in which no intersections exist alternate in the direction of the axis of the developing roller. Since two kinds of portions that differ in chargeability of toner alternate in the direction of the axis of the developing roller, vertical lines can be formed in the obtained image.

### SUMMARY

An advantage of some aspects of the invention is that a developing roller that has excellent durability and that can improve the image quality by reducing the variation in distribution and chargeability of toner in the direction of the axis of the developing roller, a developing unit having the developing roller, and an image forming apparatus having the developing unit are provided.

According to a first aspect of the invention, a developing roller includes a hollow cylindrical or solid cylindrical main body having a grooved portion that is formed in the outer circumferential surface of the main body and that supports toner. The grooved portion includes a plurality of first grooves parallel to each other and a plurality of second grooves parallel to each other and intersecting with the first grooves. The centers of four intersections at which adjacent two of the first grooves and adjacent two of the second grooves intersect differ from each other in the position in the direction of the axis of the main body.

Therefore, the developing roller has excellent durability and can improve the image quality by reducing the variation in distribution and chargeability of toner in the direction of the axis of the developing roller.

It is preferable that the four intersections be spaced from each other in the direction of the axis of the main body.

In this case, the variation in distribution and chargeability of toner in the direction of the axis of the developing roller can be made smaller.

It is preferable that the direction in which each first groove extends and the direction in which each second groove extends be inclined to the circumferential direction of the main body.

In this case, toner can be prevented from being located on one side in the direction of the axis of the main body. As a result, the image quality can be improved.

It is preferable that a relationship θ1+θ2≠180 be satisfied, where θ1 [°] is an angle formed by a line segment parallel to the axis of the main body on the outer circumferential surface of the main body and a line segment extending in the direction in which each first groove extends, and θ2 [°] is an angle formed by a line segment parallel to the axis of the main body on the outer circumferential surface of the main body and a line segment extending in the direction in which each second groove extends.

In this case, the grooved portion can be formed comparatively easily.

It is preferable that the pitch of the first grooves and the pitch of the second grooves differ from each other.

In this case, the grooved portion can be formed comparatively easily.

According to a second aspect of the invention, a developing unit includes a developing roller including a hollow cylindrical or solid cylindrical main body having a grooved portion that is formed in the outer circumferential surface of the main body and that supports toner. The grooved portion includes a plurality of first grooves parallel to each other and a plurality of second grooves parallel to each other and intersecting with the first grooves. The centers of four intersections at which adjacent two of the first grooves and adjacent two of the second grooves intersect differ from each other in the position in the direction of the axis of the main body.

Therefore, the developing unit has excellent durability and can improve the image quality by reducing the variation in distribution and chargeability of toner in the direction of the axis of the developing roller.

According to a third aspect of the invention, an image forming apparatus includes a developing unit including a developing roller including a hollow cylindrical or solid cylindrical main body having a grooved portion that is formed in the outer circumferential surface of the main body and that supports toner. The grooved portion includes a plurality of first grooves parallel to each other and a plurality of second grooves parallel to each other and intersecting with the first grooves. The centers of four intersections at which adjacent two of the first grooves and adjacent two of the second grooves intersect differ from each other in the position in the direction of the axis of the main body.

Therefore, the image forming apparatus has excellent durability and can improve the image quality by reducing the variation in distribution and chargeability of toner in the direction of the axis of the developing roller.

### BRIEF DESCRIPTION OF THE DRAWINGS

The invention will be described with reference to the accompanying drawings, wherein like numbers reference like elements.

FIG. 1 is a schematic sectional view showing the structure of an image forming apparatus according to a first embodiment of the invention.

FIG. 2 is a schematic sectional view showing the structure of a developing unit incorporated in the image forming apparatus shown in FIG. 1.

FIG. 3 is a schematic plan view showing the structure of a developing roller incorporated in the developing unit shown in FIG. 2.

FIG. 4 is an enlarged view showing the outer circumferential surface of the developing roller shown in FIG. 3.

FIG. 5 is a sectional view taken along line V-V of FIG. 4.

FIG. 6 is an enlarged view showing the outer circumferential surface of a developing roller according to a second embodiment of the invention.

FIG. 7 is an enlarged view showing the outer circumferential surface of a developing roller according to a third embodiment of the invention.

FIG. 8 is an enlarged view showing the outer circumferential surface of a known developing roller.

### DESCRIPTION OF EXEMPLARY EMBODIMENTS

The preferred embodiments of developing roller, developing unit, and image forming apparatus of the invention will now be described with reference to the drawings.

### First Embodiment

A first embodiment of the invention will be described.

### Image Forming Apparatus

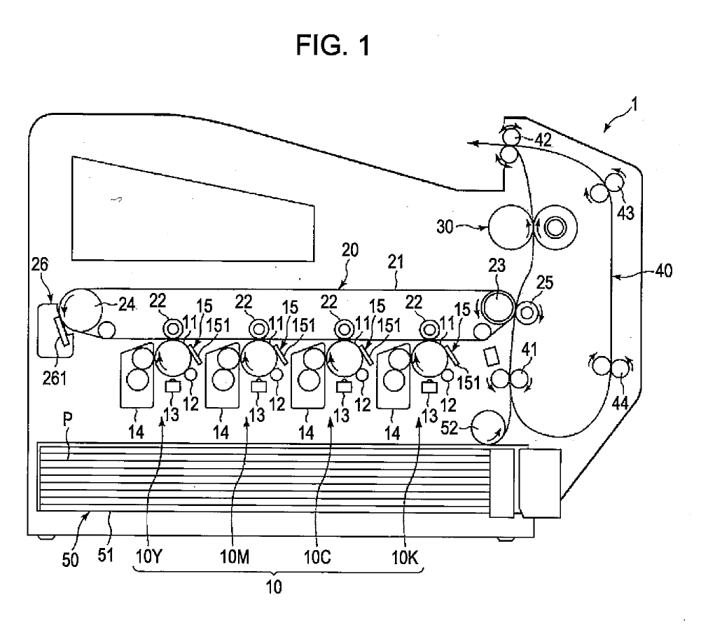

FIG. 1 is a schematic sectional view showing the structure of an image forming apparatus according to a first embodiment of the invention.

The image forming apparatus 1 shown in FIG. 1 is an electrophotographic printer that records an image on a recording medium through a series of image forming processes including a charging process, an exposing process, a developing process, a transferring process, and a fixing process. In this embodiment, the image forming apparatus 1 is a color printer using a so-called tandem method.

Such an image forming apparatus 1 has, as shown in FIG. 1, an image forming unit 10 for the charging process, exposing process, and developing process; a transfer unit 20 for the transferring process; a fixing unit 30 for the fixing process; a transporting mechanism 40 for transporting recording media P such as paper; and a paper feeding unit 50 for supplying the transporting mechanism 40 with recording media P.

The image forming unit 10 includes four image forming stations: an image forming station 10Y that forms a yellow toner image, an image forming station 10M that forms a magenta toner image, an image forming station 10C that forms a cyan toner image, and an image forming station 10K that forms a black toner image.

Each of the image forming stations 10Y, 10C, 10M, and 10K has a photosensitive drum 11 that supports an electrostatic latent image. Around the photosensitive drum 11 are disposed a charging unit 12, an exposing unit 13, a developing unit 14 according to the invention, and a cleaning unit 15.

The photosensitive drum 11 is hollow cylindrical. A photosensitive layer (not shown) is formed near the outer circumferential surface of the photosensitive drum 11. The photosensitive drum 11 is rotatable around its axis in the direction of arrow in FIG. 1.

The charging unit 12 charges the surface of the photosensitive drum 11, for example, by corona electrification.

The exposing unit 13 receives image information from a host computer (not shown) such as a personal computer and accordingly irradiates the uniformly-charged photosensitive drum 11 with a laser, thereby forming an electrostatic latent image (exposure).

The developing unit 14 supplies toner to the photosensitive drum 11 that supports the electrostatic latent image, thereby making the electrostatic latent image on the photosensitive drum 11 a visible toner image (development). The developing unit 14 will be described below in detail.

The cleaning unit 15 has a rubber cleaning blade 151 that is in contact with the surface of the photosensitive drum 11. The cleaning unit 15 scrapes and removes toner remaining on the photosensitive drum 11 after the below-described primary transfer, with the cleaning blade 151.

The transfer unit 20 transfers four colors of toner images formed on the photosensitive drums 11 of the above-described image forming stations 10Y, 10M, 10C, and 10K, all at once onto a recording medium P.

The transfer unit 20 has an endless intermediate transfer belt 21. The intermediate transfer belt 21 is stretched by a plurality of primary transfer rollers 22, a driving roller 23, and a driven roller 24. The intermediate transfer belt 21 is rotary-driven by the rotation of the driving roller 23, in the direction shown by an arrow in FIG. 1, at substantially the same circumferential speed as the circumferential speed of the photosensitive drums 11.

Each primary transfer roller 22 is disposed opposite a corresponding photosensitive drum 11 with the intermediate transfer belt 21 therebetween, and transfers the one-colored toner image on the photosensitive drum 11 onto the intermediate transfer belt 21 (primary-transfer). During the primary transfer, a primary transfer voltage (primary transfer bias) of opposite polarity to the charging polarity of toner is applied to each primary transfer roller 22.

The intermediate transfer belt 21 supports at least one of black, magenta, cyan, and yellow toner images. For example, when a full-color image is formed, four colors (black, magenta, cyan, and yellow) of toner images are sequentially transferred onto the intermediate transfer belt 21 in a superposed manner, and a full-color toner image is formed as an intermediate transfer image.

The transfer unit 20 has a secondary transfer roller 25 and a cleaning unit 26. The secondary transfer roller 25 is disposed opposite the driving roller 23 with the intermediate transfer belt 21 therebetween. The cleaning unit 26 is disposed opposite the driven roller 24 with the intermediate transfer belt 21 therebetween.

The secondary transfer roller 25 transfers a one-colored or full-color toner image (intermediate transfer image) formed on the intermediate transfer belt 21 onto a recording medium P such as a sheet of paper, a film, or a piece of cloth (secondary-transfer). During the secondary transfer, the secondary transfer roller 25 is pressed against the intermediate transfer belt 21, and a secondary transfer voltage (secondary transfer bias) is applied to the secondary transfer roller 25. During such secondary transfer, the driving roller 23 also functions as a backup roller of the secondary transfer roller 25.

The cleaning unit 26 has a rubber cleaning blade 261 that is in contact with the surface of the intermediate transfer belt 21. The cleaning unit 26 scrapes and removes toner remaining on the intermediate transfer belt 21 after the secondary transfer, with the cleaning blade 261.

The fixing unit 30 heats and presses the recording medium P onto which the toner image is transferred, thereby fusing the toner image to the recording medium P and fixing it as a permanent image.

The transporting mechanism 40 has a registration roller pair 41 and transporting roller pairs 42, 43, and 44. The registration roller pair 41 transports the recording medium P to a secondary transfer section between the secondary transfer roller 25 and the intermediate transfer belt 21 at the appropriate time. The transporting roller pairs 42, 43, and 44 nip and transport the recording medium P to which the toner image has been fixed in the fixing unit 30.

In the case of one-side image formation, an image is fixed to one side of the recording medium P by the fixing unit 30, and then the transporting roller pair 42 nips and transports the recording medium P to eject the recording medium P to the outside of the image forming apparatus 1. In the case of two-sided image formation, an image is fixed to one side of the recording medium P by the fixing unit 30, and then the transporting roller pair 42 nips the recording medium P. Thereafter, the transporting roller pair 42 is reverse-driven and the transporting roller pairs 43 and 44 are driven so that the recording medium P is reversed and returned to the registration roller pair 41. In the same way as described above, an image is formed on the other side of the recording medium P.

The paper feeding unit 50 has a paper feeding cassette 51 and a pickup roller 52. The paper feeding cassette 51 contains recording media P. The pickup roller 52 feeds the recording media P one at a time from the paper feeding cassette 51 to the registration roller pair 41.

### Developing Unit

The developing unit 14, which is an example of developing unit of the invention, will be described in detail with reference to figures.

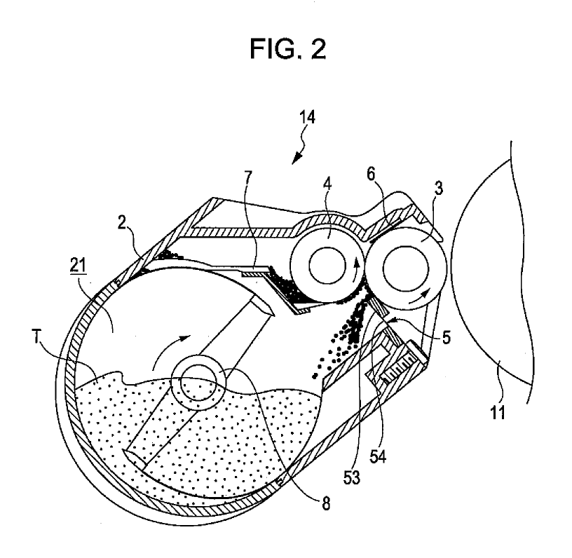

FIG. 2 is a schematic sectional view showing the structure of a developing unit incorporated in the image forming apparatus shown in FIG. 1.

The developing unit 14 shown in FIG. 2 has a housing 2, a developing roller 3, a toner supplying roller 4, and a regulating blade 5. The housing 2 contains toner T (developer). The developing roller 3 supports toner T. The toner supplying roller 4 supplies toner T to the developing roller 3. The regulating blade 5 regulates the thickness of a layer of toner T supported by the developing roller 3.

The housing 2 contains toner T in a container portion 21 formed as an internal space thereof. The housing 2 has an opening in the right side in FIG. 2. The toner supplying roller 4 and the developing roller 3 are rotatably supported near the opening. The regulating blade 5 is attached to the housing 2. A seal member 6 for preventing the toner leakage through the gap between the housing 2 and the developing roller 3 in the opening, is attached to the housing 2.

The housing 2 is provided with an agitating member 8 that agitates toner T in the container portion 21. In addition, the housing 2 is provided with a guiding member 7 disposed above the container portion 21. The guiding member 7 guides toner T that flows upward with the agitation of the agitating member 8, to the toner supplying roller 4 predetermined amount by predetermined amount.

The developing roller 3 supports toner T on its outer circumferential surface and transports toner T to a developing position between the developing roller 3 and the photosensitive drum 11 (hereinafter simply referred to as “developing position”). The developing roller 3 is hollow cylindrical and rotatable around its axis. In this embodiment, the developing roller 3 rotates in a direction opposite to the rotational direction of the photosensitive drum 11. The developing roller 3 will be described below in detail.

In this embodiment, the developing roller 3 and the photosensitive drum 11 face each other across a minute gap. Due to an alternating electric field applied between the developing roller 3 and the photosensitive drum 11, toner T flies from the developing roller 3 to the photosensitive drum 11, and the latent image on the photosensitive drum 11 is developed into a toner image.

After transported from the container portion 21 via the guiding member 7, toner T is supplied to the developing roller 3 by the toner supplying roller 4. The toner supplying roller 4 is formed, for example, of polyurethane foam. Being elastically deformed, the toner supplying roller 4 is pressed against the developing roller 3. In this embodiment, the toner supplying roller 4 rotates in a direction opposite to the rotational direction of the developing roller 3. The toner supplying roller 4 has not only a function to supply toner T to the developing roller 3 but also a function to scrape residual toner T off the developing roller 3 after the development. A voltage equal to the developing bias voltage applied to the developing roller 3 is applied to the toner supplying roller 4.

The regulating blade 5 regulates the thickness of a layer of toner T supported by the developing roller 3 and electrically charges the toner T by frictional electrification during the regulation. The regulating blade 5 also functions as a seal member that seals the gap between the housing 2 and the developing roller 3.

The regulating blade 5 has an elastic body 53 and a supporting member 54. The elastic body 53 is pressed against the developing roller 3 along the direction of the axis of the developing roller 3. The supporting member 54 supports the elastic body 53. The elastic body 53 is formed mainly, for example, of silicon rubber or urethane rubber. The supporting member 54 is an elastic sheet formed, for example, of phosphor bronze or stainless, and has a function to urge the elastic body 53 against the developing roller 3.

In this embodiment, the regulating blade 5 is disposed such that its free end faces upstream in the rotational direction of the developing roller 3, that is, it is in so-called counter contact. The developing unit 14 of this embodiment drops surplus toner on the developing roller 3 with the regulating blade 5 and returns the surplus toner to the container portion 21.

### Developing Roller

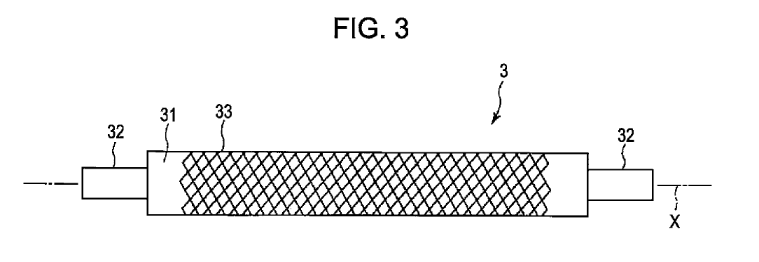

The developing roller 3, which is an example of developing roller of the invention, will be described in detail with reference to FIGS. 3 to 5.

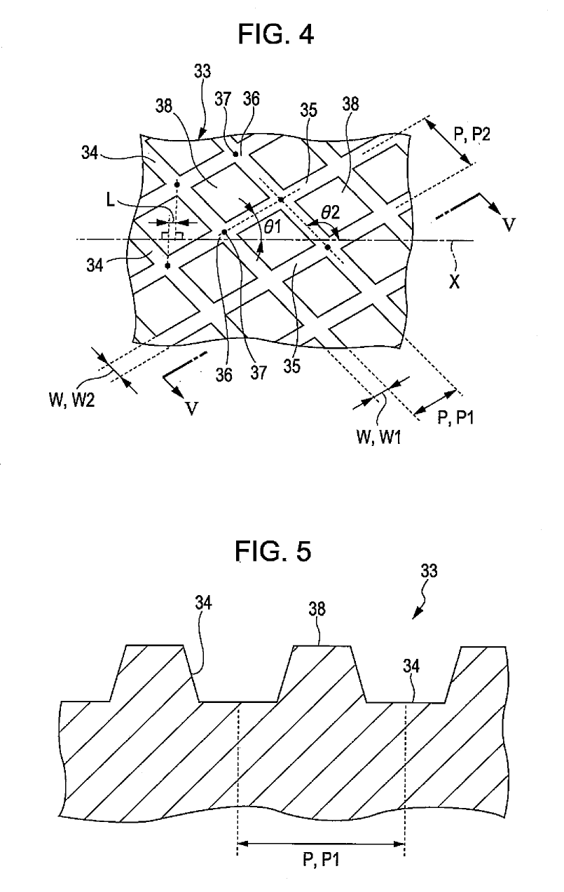

FIG. 3 is a schematic plan view showing the structure of the developing roller incorporated in the developing unit shown in FIG. 2. FIG. 4 is an enlarged view showing the outer circumferential surface of the developing roller shown in FIG. 3. FIG. 5 is a sectional view taken along line V-V of FIG. 4.

The developing roller 3 shown in FIG. 3 has a hollow cylindrical or solid cylindrical main body 31 and a pair of bearings 32 protruding from both ends of the main body 31.

As shown in FIG. 3, a grooved portion 33 for supporting toner is formed in the outer circumferential surface of the main body 31.

As shown in FIG. 4, the grooved portion 33 includes a plurality of first grooves 34 substantially parallel to each other, and a plurality of second grooves 35 substantially parallel to each other and intersecting with the first grooves 34. In the thus-configured grooved portion 33 are formed protrusions 38 each surrounded by adjacent two of the first grooves 34 and adjacent two of the second grooves 35.

The centers 37 of four intersections at which adjacent two of the first-grooves 34 and adjacent two of the second grooves 35 intersect differ from each other in the position in the direction of the axis X of the main body 31. In other words, the line segment connecting two opposite vertexes of a quadrilateral surrounded by adjacent two of the first grooves 34 and adjacent two of the second grooves 35 is inclined to the circumferential direction of the main body 31. In still other words, a quadrilateral surrounded by adjacent two of the first grooves 34 and adjacent two of the second grooves 35 is asymmetrical with respect to a line segment that passes through the center of the quadrilateral and that extends in the circumferential direction of the main body 31.

More specifically, as shown in FIG. 3, each first groove 34 spirals along the outer circumferential surface of the main body 31. In other words, as shown in FIG. 4, each first groove 34 extends in a direction inclined at an inclination angle θ1 to a line segment parallel to the axis X on the outer circumferential surface of the main body 31.

As shown in FIG. 5, the cross-section of each first groove 34 is trapezoidal. The cross-section of each first groove 34 is not limited to this and may be, for example, U-shaped or V-shaped.

Each second groove 35 spirals along the outer circumferential surface of the main body 31 in a direction opposite to that of each first groove 34. In other words, each second groove 35 extends in a direction inclined at an inclination angle θ2 different from the inclination angle θ1 of each first groove 34, to a line segment parallel to the axis X on the outer circumferential surface of the main body 31. The structure of each second groove 35 is the same as the structure of each first groove. 34, except that the extending direction of each second groove 35 differs from the extending direction of each first groove 34.

In this embodiment, although the pitch between the first grooves 34 is the same as the pitch between the second grooves 35, the first grooves 34 and the second grooves 35 differ in the inclination angle to a line segment that extends in the circumferential direction of the main body 31.

That is, a relationship θ1+θ2≠180 is satisfied, where θ1 [°] is an angle formed by a line segment parallel to the axis X of the main body 31 on the outer circumferential surface of the main body 31 and a line segment extending in the direction in which each first groove 34 extends, and θ2 [°] is an angle formed by a line segment parallel to the axis X of the main body 31 on the outer circumferential surface of the main body 31 and a line segment extending in the direction in which each second groove 35 extends.

In this case, the centers 37 of four intersections 36 at which adjacent two of the first grooves 34 and adjacent two of the second grooves 35 intersect differ from each other in the position in the direction of the axis X of the main body 31. Therefore, the above-described grooved portion 33 can be formed comparatively easily.

As described above, when the centers 37 of the four intersections 36 differ in the position in the direction of the axis X of the main body 31, a plurality of intersections 36 can be prevented from existing partly in the direction of the axis X of the main body 31. In other words, the centers 37 of a plurality of intersections 36 can be prevented from aligning in the circumferential direction of the main body 31 (the direction perpendicular to the axis X on the outer circumferential surface of the main body 31).

Since the variation in distribution and chargeability of toner in the direction of the axis X of the developing roller 3 can be made small, the image quality can be improved.

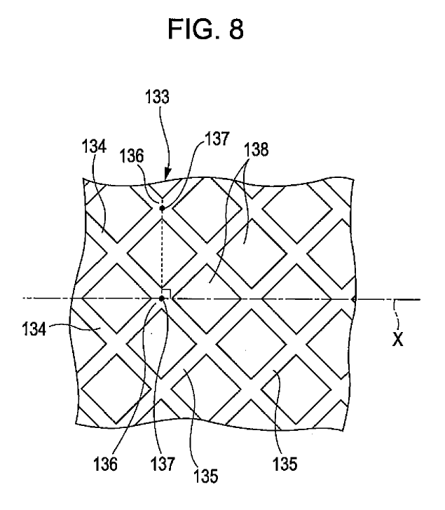

In contrast, in the case of a grooved portion 133 formed in the outer circumferential surface of a known developing roller shown in FIG. 8, the centers 137 of intersections 136 at which adjacent two of first grooves 134 and adjacent two of second grooves 135 intersect align in the circumferential direction of the main body 31 (the direction perpendicular to the axis X on the outer circumferential surface of the main body 31). Therefore, portions in which intersections 136 exist and portions in which no intersections 136 exist alternate in the direction of the axis X of the developing roller. In the portions in which intersections 136 exist in the direction of the axis X of the developing roller, the pitch of groove is larger, the probability of contact with toner is lower, and the chargeability of toner is lower compared to the portions in which no intersections 136 exist. Therefore, the toner supported by such a grooved portion 133 includes highly-charged portions and lowly-charged portions that alternate in the direction of the axis X of the developing roller. As a result, vertical lines are generated in the obtained image.

Since the grooved portion 33 is regular and uniform, a uniform and optimum amount of toner T can be supported on the developing roller 3. In addition, the rollability of toner T on the outer circumferential surface of the developing roller 3 can be uniformized. As a result, local defective charging and defective transport of toner T can be prevented, and excellent development characteristics can be achieved.

Unlike ones obtained through a blast process, such a grooved portion 33 has excellent mechanical strength because the width of the top of each protrusion 38 thereof is comparatively large. Since the grooved portion 33 is obtained through a process such as transfer (rolling) using a die, the strength of the pressed portion is improved. Therefore, the grooved portion 33 has excellent mechanical strength compared to ones obtained through a process such as cutting work. The developing roller 3 having such a grooved portion 33 has excellent endurance despite being rubbed by the regulating blade 5 and the toner supplying roller 4. Therefore, such a developing roller 3 is suitable for a developing unit in which a dry one-component nonmagnetic toner is used. Since the width of the top of each protrusion of the grooved portion 33 is comparatively large, change in shape caused by wear is small. Therefore, the development characteristics can be prevented from quickly deteriorating, and excellent development characteristics can be maintained over a long period of time.

The direction in which each first groove 34 extends and the direction in which each second groove 35 extends are inclined to the circumferential direction of the main body 31. Therefore, toner on the grooved portion 33 is transported to both ends of the main body 31 with the rotation of the developing roller 3. Therefore, toner can be prevented from being located on one side in the direction of the axis X of the main body 31. As a result, the image quality can be improved.

The main body 31 of such a developing roller 3 is formed mainly of a metal material such as aluminum, stainless, or steel. Specifically, steel materials such as STK and SGP and aluminum materials such as A6063 and A5056 are suitable for the main body 31.

The outer circumferential surface of the main body 31 may be nickel-plated or chrome-plated as needed.

The diameter (outside diameter) of the main body 31 is not limited, but is preferably 10 to 30 mm, and more preferably 15 to 20 mm.

The pitch between the first grooves 34 and the pitch between the second grooves 35 are not limited, but are preferably 50 to 150 μm, and more preferably 50 to 100 μm.

When the depth of the first grooves 34 and/or the second grooves 35 is D, and the average particle diameter of toner T (developer) is d, D/d is preferably 0.5 to 2, and more preferably 0.9 to 1.3. In this case, the obtained developing roller 3 can support a uniform and optimum amount of toner T in its grooved portion 33. If D/d is smaller than the lower limit, depending on the shape of the grooved portion 33, toner does not easily catch on the protrusions of the grooved portion 33. Therefore, the rollability of toner deteriorates and defective charging tends to occur. If D/d exceeds the upper limit, depending on the shape of the grooved portion 33, toner in the grooves of the grooved portion 33 comes into contact with neither the developing roller 3 nor the regulating blade 5 and defective charging can occur.

When the width of the first grooves 34 and/or the second grooves 35 is W (W1, W2), and the average particle diameter of toner (developer) is d, W/d is preferably 2 to 20, and more preferably 4 to 10. In this case, the developing roller 3 can support a uniform and optimum amount of toner T (developer) in its grooved portion 33. If W/d is smaller than the lower limit, depending on the shape of the grooved portion 33, toner does not enter the grooves, and therefore the rollability of toner deteriorates and defective charging tends to occur. If toner enters the grooves, the toner stays in the grooves, and therefore filming tends to occur. If W/d exceeds the upper limit, depending on the shape of the grooved portion 33, the amount of toner supported by the developing roller 3 is small and therefore defective transport can occur, or toner has less opportunity to come into contact with the protrusions of the grooved portion 33 and the rollability deteriorates and therefore defective charging can occur.

The width of the first grooves 34 may be the same as or differ from the width of the second grooves 35.

Such a developing roller 3, and a developing unit and an image forming apparatus having the developing roller 3 has excellent development characteristics and durability.

### Second Embodiment

Next, a second embodiment of the invention will be described.

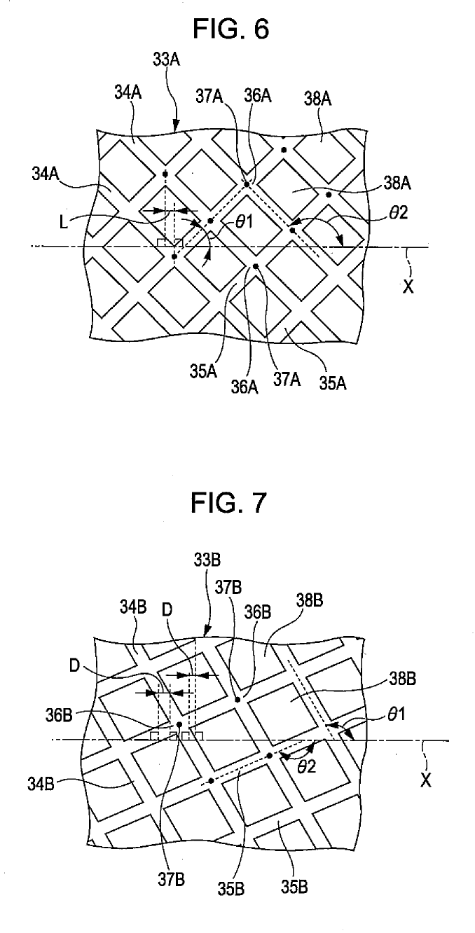

FIG. 6 is an enlarged view showing the outer circumferential surface of a developing roller according to a second embodiment of the invention.

The description of the second embodiment will be centered on the differences from the first embodiment. The description of the same components as those in the first embodiment will be omitted.

As shown in FIG. 6, the developing roller of the second embodiment is the same as the developing roller 3 of the first embodiment, except that the developing roller of the second embodiment differs from the developing roller 3 of the first embodiment in the structure of the grooved portion.

The grooved portion 33A formed in the outer circumferential surface of the main body of the developing roller according to this embodiment includes a plurality of first grooves 34A substantially parallel to each other, and a plurality of second grooves 35A substantially parallel to each other and intersecting with the first grooves 34A.

As shown in FIG. 6, although the inclination angle θ1 of a line segment extending in the direction in which each first groove 34A extends to a line segment parallel to the axis X of the main body on the outer circumferential surface of the main body of the developing roller is the same as the inclination angle θ2 of a line segment extending in the direction in which each second groove 35A extends to a line segment parallel to the axis X of the main body on the outer circumferential surface of the main body, the pitch between the first grooves 34A differs from the pitch between the second grooves 35A.

When the pitch of the first grooves 34A and the pitch of the second grooves 35A differs from each other, the centers 37A of four intersections 36A at which adjacent two of the first grooves 34A and adjacent two of the second grooves 35A intersect differ from each other in the position in the direction of the axis X. Therefore, the above-described grooved portion 33A can be formed comparatively easily.

The above-described developing roller according to this embodiment has the same advantages as those of the developing roller according to the first embodiment.

### Third Embodiment

Next, a third embodiment of the invention will be described.

FIG. 7 is an enlarged view showing the outer circumferential surface of a developing roller according to a third embodiment of the invention.

The description of the third embodiment will be centered on the differences from the first embodiment. The description of the same components as those in the first embodiment will be omitted.

As shown in FIG. 7, the developing roller of the third embodiment is the same as the developing roller 3 of the first embodiment, except that the developing roller of the third embodiment differs from the developing roller 3 of the first embodiment in the structure of the grooved portion.

The grooved portion 33B formed in the outer circumferential surface of the main body of the developing roller according to this embodiment includes a plurality of first grooves 34B substantially parallel to each other, and a plurality of second grooves 35B substantially parallel to each other and intersecting with the first grooves 34B.

As shown in FIG. 7, although the pitch between the first grooves 34B is the same as the pitch between the second grooves 35B, the first grooves 34B and the second grooves 35B differ in the inclination angle to a line segment that extends in the circumferential direction of the main body.

The first grooves 34B and the second grooves 35B significantly differ in the inclination angle, and four intersections 36B at which adjacent two of the first grooves 34B and adjacent two of the second grooves 35B intersect are spaced from each other in the direction of the axis X of the main body.

Therefore, a plurality of intersections 36 can be more reliably prevented from existing partially in the direction of the axis X of the main body. As a result, the variation in distribution and chargeability of toner in the direction of the axis X of the developing roller can be made smaller.

The above-described developing roller according to this embodiment has the same advantages as those of the developing roller according to the first embodiment.

### EXAMPLES

Next, specific examples of the invention will be described.

### Fabrication of Developing Roller

### Example 1

A developing roller was fabricated as follows.

First, a hollow cylindrical STKM base material was prepared. The base material was 300 mm in length, 18 mm in outside diameter, and 3 mm in thickness.

At each end of the base material, the inner circumferential surface was cut so that the thickness is reduced by about 1 mm. A solid cylindrical STKM member was pressed into each end of the base material. The solid cylindrical member was 50 mm in length and 14 mm in outside diameter. The solid cylindrical member was pressed into each end of the base material so as to be left exposed by about 30 mm.

Thereafter, the structure consisting of the base material and the pair of solid cylindrical members was ground by centerless grinding so that the axis of the base material corresponds to the axes of the solid cylindrical members.

Next, a plurality of first grooves and a plurality of second grooves were formed in the outer circumferential surface of the base material using an SKD die. Thereafter, the outer circumferential surface of the base material was hard-nickel-plated. The thickness of plating was 3 μm. In this way, a grooved portion including a plurality of first grooves and a plurality of second grooves was formed. The first grooves and second grooves were formed as shown in Table 1 (with respect to pitch P, width W, inclination angle θ1, θ2 to the axis of the roller, distance L between the centers of intersections in the direction of the axis, and overlap between intersections in the direction of the axis).

TABLE 1

| | First grooves | | | Second grooves | | | | |
|---|---|---|---|---|---|---|---|---|
| | Pitch | Width | Angle | Pitch | Width | Angle | Distance | |
| | P [μm] | W [μm] | θ1 [°] | P [μm] | W [μm] | θ2 [°] | L [μm] | Overlap |
| Example 1 | 100 | 26 | 30 | 100 | 26 | 135 | 15.89 | Overlapped |
| Example 2 | 100 | 26 | 45 | 80 | 26 | 135 | 14.1 | Overlapped |
| Example 3 | 100 | 26 | 22.5 | 100 | 26 | 120 | 42.4 | Not overlapped |
| Comparative example | 100 | 26 | 45 | 100 | 26 | 135 | 0 | Overlapped |

In this way, a developing roller was fabricated.

### Example 2

A developing roller was fabricated in the same manner as Example 1, except that the configuration of the grooved portion differs as shown in Table 1.

### Example 3

A developing roller was fabricated in the same manner as Example 1, except that the configuration of the grooved portion differs as shown in Table 1.

### Comparative Example

A developing roller was fabricated in the same manner as Example 1, except that the configuration of the grooved portion differs as shown in Table 1.

### Evaluation

Each of the developing rollers of Example 1 to 3 and the comparative example was incorporated into a printer (Epson LP-9000C). Images of 25% and 50% printing rates are printed on recording paper (made by Fuji Xerox Co., Ltd., high-quality paper, J paper). Generation of vertical lines was observed with the eye. The evaluation result is shown in Table 2.

TABLE 2

| | 25% printing | 50% printing |
|---|---|---|
| Example 1 | Vertical lines were | No vertical lines were observed |
| | locally observed | |
| Example 2 | Vertical lines were | No vertical lines were observed |
| | locally observed | |
| Example 3 | No vertical lines | No vertical lines were observed |
| | were observed | |
| Comparative | Vertical lines were | Vertical lines were widely |
| example | widely observed | observed |

In such evaluation, a non-contact jumping development method was used in which a gap (developing gap) is provided between a developing roller and a photosensitive drum, and a developing bias is applied to the developing roller so that toner flies across the developing gap. The developing gap was 140 μm. The electric potential of the photosensitive drum (V0) was −500 V. The developing bias is a superposition of a direct current component Vdc of —300 V in voltage and an alternating current component of 3 kHz in frequency, 1400 V in peak-to-peak voltage (Vpp), 60% in Duty, and rectangular wave.

As is clear from Table 2, in each example according to the invention, the image of 50% printing was quite free from vertical lines and of excellent quality. In particular, in Example 3, the image of 25% printing was also quite free from vertical lines and of excellent quality.

In contrast, in the comparative example, significant vertical lines were observed in each of 25% printing and 50% printing.

Although the preferred embodiments of the invention are described above, the invention is not limited to these embodiments. Each component of a developing roller, a developing unit, and an image forming apparatus can be replaced with any other component having the same function. Any components may be added.

The shape of the grooved portion formed on the outer circumferential surface of the developing roller is not limited to those of the above-described embodiments as long as four intersections at which adjacent two of the first grooves and adjacent two of the second grooves intersect differ in the position in the direction of the axis of the developing roller.

What is claimed is:

1. A developing roller comprising:
a hollow cylindrical or solid cylindrical main body having a grooved portion that is formed in the outer circumferential surface of the main body and that supports toner,
wherein the grooved portion includes a plurality of first grooves parallel to each other and a plurality of second grooves parallel to each other and intersecting with the first grooves, and
wherein the centers of four intersections at which adjacent two of the first grooves and adjacent two of the second grooves intersect differ from each other in the position in the direction of the axis of the main body.

2. The developing roller according to claim 1, wherein the four intersections are spaced from each other in the direction of the axis of the main body.

3. The developing roller according to claim 1, wherein the direction in which each first groove extends and the direction in which each second groove extends are inclined to the circumferential direction of the main body.

4. The developing roller according to claim 3, wherein a relationship θ1+θ2≠180 is satisfied, where θ1 [°] is an angle formed by a line segment parallel to the axis of the main body on the outer circumferential surface of the main body and a line segment extending in the direction in which each first groove extends, and θ2 [°] is an angle formed by a line segment parallel to the axis of the main body on the outer circumferential surface of the main body and a line segment extending in the direction in which each second groove extends.

5. The developing roller according to claim 1, wherein the pitch of the first grooves and the pitch of the second grooves differ from each other.

6. A developing unit comprising:
a developing roller including a hollow cylindrical or solid cylindrical main body having a grooved portion that is formed in the outer circumferential surface of the main body and that supports toner,
wherein the grooved portion includes a plurality of first grooves parallel to each other and a plurality of second grooves parallel to each other and intersecting with the first grooves, and
wherein the centers of four intersections at which adjacent two of the first grooves and adjacent two of the second grooves intersect differ from each other in the position in the direction of the axis of the main body.

7. An image forming apparatus comprising:
a developing unit including a developing roller including a hollow cylindrical or solid cylindrical main body having a grooved portion that is formed in the outer circumferential surface of the main body and that supports toner, p1 wherein the grooved portion includes a plurality of first grooves parallel to each other and a plurality of second grooves parallel to each other and intersecting with the first grooves, and
wherein the centers of four intersections at which adjacent two of the first grooves and adjacent two of the second grooves intersect differ from each other in the position in the direction of the axis of the main body.
